(19) United States
(12) Patent Application Publication
(10) Pub. No.: US 2026/0318802 A1
(43) Pub. Date: Oct. 15, 2026

(54) BUBBLE POINT PRESSURE DETERMINATION DURING FLOWLINE DECOMPRESSION EXPERIMENTS

(71) Applicant: Schlumberger Technology Corporation, Sugar Land, TX (US)

(72) Inventors: Adriaan Gerard Gisolf, Bucharest (RO); Ahmed Moge Ali, Dhahran (SA); Mikhail Charupa, Dhahran (SA); Mustapha Berkane, Dhahran (SA)

(21) Appl. No.: 19/642,157

(22) Filed: Apr. 8, 2026

Related U.S. Application Data
(60) Provisional application No. 63/786,084, filed on Apr. 9, 2025.

(51) Int. Cl. G01N 7/14; E21B 49/08; G01L 11/02

(52) U.S. Cl. CPC G01N 7/14; E21B 49/0815; E21B 49/0875; E21B 49/088; G01L 11/02

(57) ABSTRACT

A method for determining a bubble point pressure of a formation fluid during a flowline decompression experiment includes isolating a volume of the formation fluid in a flowline of a formation testing tool. The method includes increasing a volume of a displacement unit in fluid communication with the flowline via a check valve to cause an initial reduction in a pressure of the formation fluid in the flowline. The method includes detecting, during the increasing the volume, a temporary increase in the pressure after the initial reduction of the pressure. The method includes detecting, during the increasing the volume, a continued reduction in the pressure after the temporary increase in the pressure. The method includes determining the bubble point pressure based on the detecting the temporary increase in the pressure.

### CROSS-REFERENCE TO RELATED APPLICATIONS

This application claims priority to U.S. Provisional Application No. 63/786084, filed Apr. 9, 2025, which is hereby incorporated by reference in its entirety.

### BACKGROUND

Formation testing tools deployed in wellbores are used to obtain and analyze formation fluids to determine various fluid properties. Detecting phase changes in formation fluids, such as the transition from single-phase liquid to two-phase liquid-gas mixtures at the bubble point, or the formation of liquid droplets at the dew point, provides valuable information about reservoir fluid characteristics. Optical spectroscopy measurements can detect phase changes by observing light scattering caused by bubbles or dew drops in the flowline. However, the interaction between check valve behavior, pressure dynamics in the displacement unit versus the main flowline, and the timing of phase change detection presents challenges in accurately determining saturation pressure and distinguishing between different types of formation fluids during downhole decompression experiments.

### SUMMARY

According to an aspect of the present disclosure, a method for determining a bubble point pressure of a formation fluid during a flowline decompression experiment is provided. The method includes isolating the formation fluid in a flowline of a formation testing tool. The method includes increasing a volume of a displacement unit in fluid communication with the flowline via a check valve to cause an initial reduction in a pressure of the formation fluid in the flowline. The method includes detecting, during the increasing the volume, a temporary increase in the pressure after the initial reduction of the pressure. The method includes detecting, during the increasing the volume, a continued reduction in the pressure after the temporary increase in the pressure. The method includes determining the bubble point pressure based on the detecting the temporary increase in the pressure.

According to other aspects of the present disclosure, the method may include one or more of the following features. The method may further include monitoring an optical density in the flowline using an optical sensor. The method may further include detecting, based on the monitoring, optical density scattering in the flowline corresponding in time to the continued reduction in the pressure. The method may further include confirming the bubble point pressure based on a pressure value at which the optical density scattering is detected. The detecting the temporary increase in the pressure may include measuring a pressure in the flowline via a pressure gauge. The initial reduction in the pressure may open the check valve. The temporary increase in the pressure may temporarily close the check valve. The determining the bubble point pressure may include detecting a time when the check valve temporarily closes and measuring the pressure in the flowline via a pressure gauge at the time. Increasing the volume of the displacement unit may include moving a piston disposed in the displacement unit. The check valve may have a cracking pressure such that a pressure in the displacement unit is lower than the pressure in the flowline during the increasing the volume. The bubble point pressure may be reached in the displacement unit before the bubble point pressure is reached in the flowline. The method may further include detecting formation of bubbles in the displacement unit during the increasing the volume, wherein the formation of the bubbles causes the temporary increase in the pressure. The formation testing tool may be disposed in a wellbore, and the method may be performed downhole.

According to another aspect of the present disclosure, a system for determining a bubble point pressure during a flowline decompression experiment is provided. The system includes a formation testing tool configured to isolate a formation fluid in a flowline. The system includes a displacement unit in fluid communication with the flowline. The displacement unit includes a displacement pump configured to reduce a pressure in the flowline. The system includes a pressure sensor configured to measure the pressure in the flowline. The system includes a controller electrically coupled to the displacement pump and the pressure sensor. The controller is configured to cause the displacement pump to increase a volume of the displacement unit resulting in an initial reduction in the pressure of the formation fluid in the displacement unit. The controller is configured to cause the pressure sensor to measure a temporary increase in the pressure while the displacement pump continues to increase the volume. The controller is configured to determine the bubble point pressure based on the temporary increase in the pressure.

According to other aspects of the present disclosure, the system may include one or more of the following features. The system may further include an optical sensor configured to monitor an optical density in the flowline. The controller may be further configured to detect optical density scattering in the flowline corresponding in time to a continued reduction in the pressure after the temporary increase in the pressure. The system may further include a check valve disposed between the flowline and the displacement unit. The check valve may have a cracking pressure. A pressure in the displacement unit may be lower than the pressure in the flowline during operation of the displacement pump. The check valve may be configured to temporarily close in response to the temporary increase in the pressure caused by formation of bubbles in the displacement unit. The displacement pump may include a piston configured to move within the displacement unit to increase the volume of the displacement unit. The formation testing tool may be configured for deployment in a wellbore. The controller may be configured to determine the bubble point pressure downhole.

According to another aspect of the present disclosure, a method for distinguishing between a bubble point and a dew point during a flowline decompression experiment is provided. The method includes isolating a formation fluid in a flowline of a formation testing tool. The method includes increasing a volume of a displacement unit in fluid communication with the flowline to reduce a pressure of the formation fluid. The method includes monitoring the pressure in the flowline during the increasing the volume. The method includes detecting whether a temporary increase in the pressure occurs after an initial reduction in the pressure. The method includes determining a bubble point pressure of the formation fluid in response to detecting the temporary increase in the pressure. The method includes determining a dew point of the formation fluid in response to not detecting the temporary increase in the pressure.

According to other aspects of the present disclosure, the method may include one or more of the following features. The method may further include monitoring an optical density in the flowline using an optical sensor. The method may further include detecting optical density scattering in the flowline, wherein the optical density scattering confirms a phase change in the formation fluid. The displacement unit may be in fluid communication with the flowline via a check valve. The temporary increase in the pressure may be caused by formation of gas bubbles in the displacement unit that expand and temporarily close the check valve. The check valve may have a cracking pressure such that the pressure in the displacement unit is lower than the pressure in the flowline during the increasing the volume. A phase change may occur in the displacement unit before occurring in the flowline. The formation testing tool may be disposed in a wellbore, and the method may be performed downhole.

### BRIEF DESCRIPTION OF FIGURES

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 illustrates a system for performing formation testing operations in a wellbore environment, according to aspects of the present disclosure;

FIG. 2 illustrates a formation testing tool workflow configured for performing flowline decompression experiments, according to aspects of the present disclosure;

FIG. 3A illustrates a formation testing tool during a first stage of a flowline decompression experiment, according to aspects of the present disclosure;

FIG. 3B illustrates the formation testing tool of FIG. 3A during a second stage of the flowline decompression experiment, according to aspects of the present disclosure;

FIG. 3C illustrates the formation testing tool of FIG. 3A during a third stage of the flowline decompression experiment, according to aspects of the present disclosure;

FIG. 4 depicts a graph showing pressure and optical density measurements during a flowline decompression experiment, according to aspects of the present disclosure;

FIG. 5 depicts a graph showing measurement data during a flowline decompression experiment, according to aspects of the present disclosure; and

FIG. 6 illustrates a block diagram of a controller computer system, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to methods and systems for determining a bubble point pressure of a formation fluid during a flowline decompression experiment. Formation testing operations performed in wellbore environments may involve characterizing fluid properties of formation fluids obtained from subsurface formations. Determining the bubble point pressure of a formation fluid may provide information regarding the saturation pressure at which dissolved gases begin to evolve from the liquid phase of the formation fluid. Accurate determination of bubble point pressure may enable operators to make informed decisions regarding reservoir management, production strategies, and fluid handling procedures.

In at least one embodiment, a method for determining a bubble point pressure of a formation fluid during a flowline decompression experiment may be performed using a formation testing tool disposed in a wellbore. The method may involve isolating a volume of formation fluid in a flowline of the formation testing tool and reducing the pressure of the isolated fluid using a displacement unit connected to the flowline via a check valve. The check valve may have a cracking pressure that causes the pressure within the displacement unit to be lower than the pressure in the flowline during decompression operations. As a result, the bubble point pressure may be reached within the displacement unit before the bubble point pressure is reached in the main flowline.

When the bubble point pressure is reached within the displacement unit, gas bubbles may form and expand. The expansion of the gas bubbles may cause the check valve to temporarily close, which may result in a temporary increase in the pressure measured in the flowline. Detecting this temporary pressure increase may enable determination of the bubble point pressure of the formation fluid. The temporary pressure increase may serve as an indicator that the bubble point pressure has been reached, and the pressure value at which this event occurs may be recorded as the bubble point pressure.

The methods and systems described herein may provide advantages for downhole formation testing operations. Real-time determination of bubble point pressure may be performed without requiring fluid samples to be transported to surface laboratories for pressure-volume-temperature (PVT) analysis. The ability to characterize formation fluids in situ may reduce operational time and enable faster decision-making during drilling and formation evaluation operations. In at least one embodiment, the methods may be performed at any time during formation testing operations and may be applied to a wide range of downhole fluids.

In at least one embodiment, the methods described herein may enable distinguishing between bubble point fluids and dew point fluids. For bubble point fluids, the formation of gas bubbles in the displacement unit may cause a measurable volume change that results in the temporary pressure increase described above. For dew point fluids, the formation of liquid droplets (dew drops) may not cause a measurable volume change, and the temporary pressure increase may not be observed. The presence or absence of the temporary pressure increase during a flowline decompression experiment may therefore serve as an indicator of whether the formation fluid is a bubble point fluid or a dew point fluid.

The methods and systems described herein may be combined with optical sensing techniques to confirm bubble point pressure determinations. Optical sensors positioned in the flowline may detect optical density scattering caused by the presence of gas bubbles or liquid droplets in the formation fluid. The onset of optical density scattering may correspond in time to the continued reduction in pressure after the temporary pressure increase, providing confirmation of the bubble point pressure value. The combination of pressure monitoring and optical sensing may enhance the accuracy and reliability of bubble point pressure determinations during flowline decompression experiments.

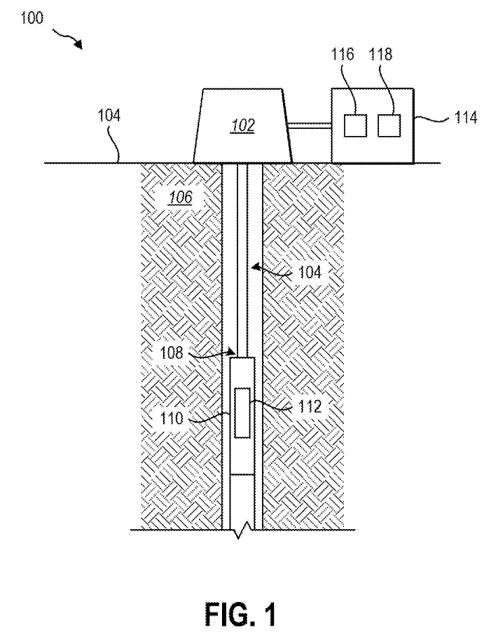

FIG. 1 illustrates an example of a system 100 for performing formation testing operations in a wellbore environment. The system 100 may include a rig 102 positioned at a surface location. The rig 102 may support drilling operations and formation testing operations performed in a subsurface environment. A wellbore 104 may extend downward from the rig 102 into a formation 106. The formation 106 may surround the wellbore 104 and may represent a geological structure being evaluated for hydrocarbon content or other fluid properties.

A tool string 108 may be disposed within the wellbore 104. The tool string 108 may extend from the rig 102 downward into the formation 106. The tool string 108 may include a downhole tool 110 positioned along a length of the tool string 108. The downhole tool 110 may include a formation testing tool 112 configured to perform formation testing operations. The formation testing tool 112 may be disposed in the wellbore 104 and may be configured for deployment in the wellbore 104 to perform flowline decompression experiments for determining fluid properties such as bubble point pressure. In at least one embodiment, the formation testing tool 112 may perform the methods described herein downhole, enabling in situ characterization of formation fluids without requiring fluid samples to be transported to surface facilities.

As shown in FIG. 1, the system 100 may include a surface facility 114 positioned at the surface location. The surface facility 114 may house equipment for controlling and monitoring formation testing operations performed by the formation testing tool 112. The surface facility 114 may include a controller 116 and surface equipment 118, for example pumps, filters, and so forth. The controller 116 may be electrically coupled to the formation testing tool 112 via the tool string 108 connection or other connection such as a wireline. The controller 116 may be configured to manage operation of the downhole tool 110 and the formation testing tool 112. The controller 116 may be configured to determine the bubble point pressure downhole by processing data received from downhole sensors, including pressure sensors and optical sensors positioned in the formation testing tool 112. The controller 116 may control a displacement unit during flowline decompression experiments and may detect temporary pressure increases indicative of bubble point conditions. The surface equipment 118 may provide additional support functions for formation testing operations conducted by the system 100.

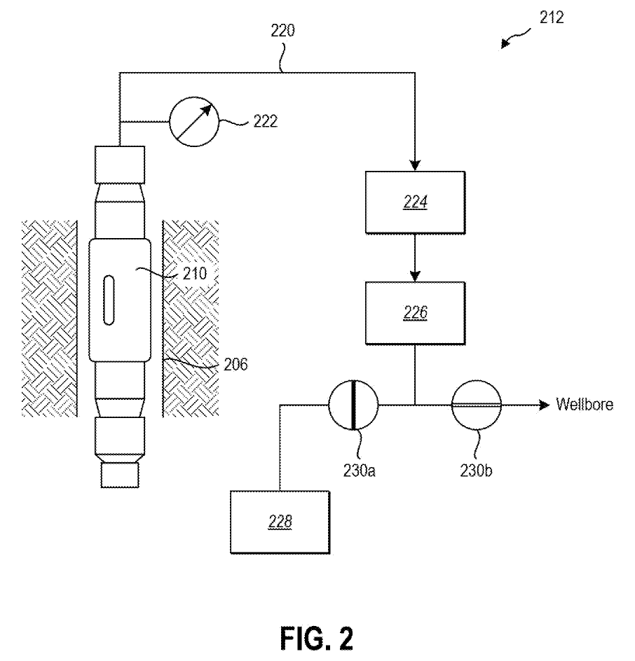

FIG. 2 illustrates a formation testing tool workflow 212 configured for performing flowline decompression experiments. The formation testing tool workflow 212 may include the use of a downhole tool 210 positioned within a formation 206. The formation 206 may surround the downhole tool 210 and may represent a subsurface geological structure from which formation fluid may be obtained. The downhole tool 210 may be configured to obtain formation fluid from the formation 206 and introduce the formation fluid into an isolated flowline for subsequent analysis and characterization.

A flowline 220 may extend from the downhole tool 210 and may connect various components of the formation testing tool workflow 212. The flowline 220 may be configured to isolate a volume of formation fluid therein. As described previously, isolating a volume of the formation fluid in a flowline of a formation testing tool may enable subsequent decompression operations for determining bubble point pressure or for distinguishing between a bubble point fluid and a dew point fluid during a flowline decompression experiment.

As shown in FIG. 2, a pressure gauge 222 may interface with the flowline 220. The pressure gauge 222 may be configured to measure pressure in the flowline 220 during formation testing operations. The pressure gauge 222 may function as a pressure sensor configured to measure pressure in the flowline 220. The controller 116 described previously may be electrically coupled to the pressure gauge 222 and may receive pressure measurements therefrom during flowline decompression experiments.

A fluid analyzer 224 may be connected to the flowline 220. The fluid analyzer 224 may be configured to analyze properties of the formation fluid flowing through the flowline 220. The fluid analyzer 224 may include optical sensors for monitoring optical density and detecting optical density scattering indicative of phase changes in the formation fluid. In at least one embodiment, the fluid analyzer 224 may perform optical spectroscopy measurements at a sampling rate of approximately 128 milliseconds to detect phase change events during decompression operations.

A pump module 226 may be connected to the flowline 220. The pump module 226 may be configured to control fluid flow and pressure within the flowline 220. The pump module 226 may be positioned either above or below the fluid analyzer 224 in the formation testing tool workflow 212. The positioning of the pump module 226 relative to the fluid analyzer 224 may be selected based on operational requirements and tool configuration. The pump module 226 may function as a displacement pump configured to reduce a pressure in the flowline 220 during flowline decompression experiments.

In at least one embodiment, a displacement unit 228 may be connected to the flowline 220. The displacement unit 228 may be in fluid communication with the flowline 220 via a first check valve 230a and a second check valve 230b. The first check valve 230a may be positioned between the pump 226 and the displacement unit 228, while the second check valve 230b may be positioned between the displacement unit 228 and a wellbore outlet. The pump 226 may be used to change pressure and volume of the displacement unit 228 during decompression operations. Increasing a volume of the displacement unit 228 in fluid communication with the flowline 220 via a check valve may cause an initial reduction in a pressure of the formation fluid in the flowline 220.

The check valves 230a and 230b may control the direction of fluid flow and may have cracking pressures that affect the pressure differential between the displacement unit 228 and the flowline 220 during decompression operations. The arrangement of the displacement unit 228 in fluid communication with the flowline 220 may enable controlled pressure reduction for determining bubble point pressure during flowline decompression experiments. The controller 116 may be electrically coupled to the pump 226 and the pressure gauge 222, and the controller 116 may be configured to control operation of the displacement unit 228 and process pressure measurements received from the pressure gauge 222.

The flowrate used for the flowline decompression experiment may range from approximately 0.1 cubic centimeters per second (cc/sec) to approximately 0.5 cc/sec, depending on the fluid compressibility and the isolated flowline volume. In at least one embodiment, the flowrate may range from approximately 0.05 cc/sec to approximately 0.8 cc/sec. Higher flowrates between approximately 0.5 cc/sec and approximately 5 cc/sec may be used for more compressible fluids and for larger decompression volumes, such as when multiple sample capture modules are connected to the section of flowline to decompress in combination with light fluids. In at least one embodiment, flowrates between approximately 0.3 cc/sec and approximately 8 cc/sec may be used for highly compressible fluids or large decompression volumes.

A target decompression rate of approximately 10 pounds per square inch per second (psi/sec) to approximately 50 psi/sec may be used to ensure that the decompression does not last more than a few minutes. In at least one embodiment, the decompression rate may range from approximately 5 psi/sec to approximately 75 psi/sec. In at least one embodiment, the decompression rate may range from approximately 8 psi/sec to approximately 100 psi/sec. Maintaining the decompression within a timeframe of minutes may ensure isothermal conditions and may minimize interference with formation testing operations. The temperature change observed during the decompression experiment may be maintained below approximately 0.5 degrees Celsius.

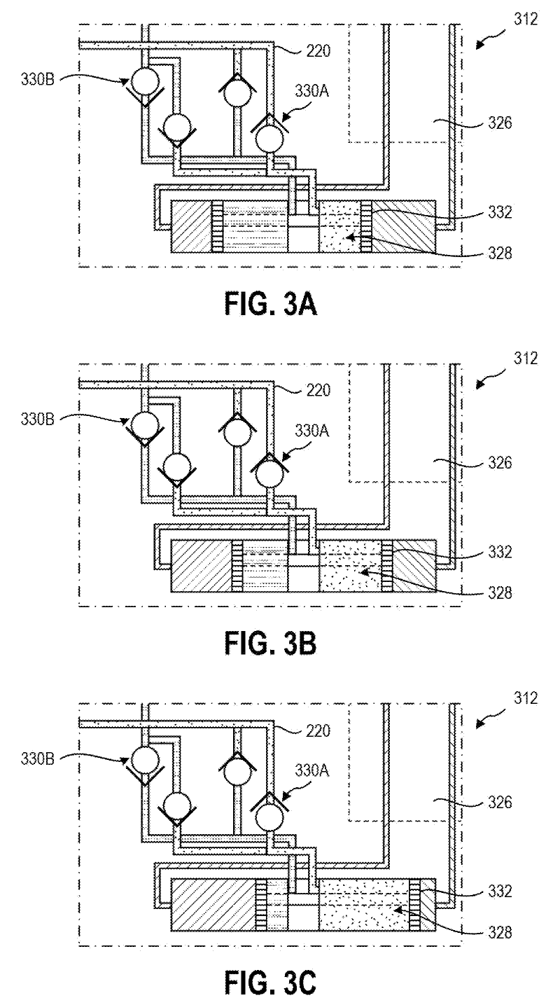

Referring to FIGS. 3A, 3B, and 3C, a formation testing tool 312 configured for performing flowline decompression experiments is shown in three different stages of an experiment. The formation testing tool 312 may include a pump 326, for example a hydraulic pump, connected thereto. The pump 326 may be configured to control fluid flow during the decompression experiment. A displacement unit 328 may be in fluid communication with the flowline through a first check valve 330a and a second check valve 330b. The first check valve 330a may be disposed between the flowline and the displacement unit 328. The second check valve 330b may be positioned between the displacement unit 328 and a wellbore outlet. A piston 332 may be disposed within the displacement unit 328. The piston 332 may be configured to move within the displacement unit 328 to increase a volume of the displacement unit 328. The displacement pump may include the piston 332 configured to move within the displacement unit 328 to increase the volume of the displacement unit 328.

The first check valve 330a may have a cracking pressure. The cracking pressure of the first check valve 330a may range from approximately 50 psi to approximately 100 psi. In at least one embodiment, the cracking pressure may range from approximately 25 psi to approximately 150 psi. In at least one embodiment, the cracking pressure may range from approximately 10 psi to approximately 200 psi. The cracking pressure may be adjusted to higher or lower pressures based on operational requirements, fluid properties, and tool configuration. Factors affecting the cracking pressure range may include the viscosity of the formation fluid, the expected pressure differential during decompression operations, and the mechanical design of the check valve components and the expected pressure in the wellbore and flowline.

Because of the cracking pressure of the first check valve 330a, a pressure in the displacement unit 328 may be lower than the pressure in the flowline during operation of the displacement pump. The pressure differential between the displacement unit 328 and the flowline may be approximately equal to the cracking pressure of the first check valve 330a. As a result, the bubble point pressure may be reached in the displacement unit 328 before the bubble point pressure is reached in the flowline. A phase change may occur in the displacement unit 328 before occurring in the flowline due to the lower pressure maintained within the displacement unit 328 during decompression operations.

As shown in FIG. 3A, the piston 332 may be positioned in a first position within the displacement unit 328. The first check valve 330a may be in an open configuration allowing fluid to flow from the flowline into the displacement unit 328. The second check valve 330b may also be positioned to control fluid flow out of the displacement unit 328.

As shown in FIG. 3B, the piston 332 may have moved to a second position within the displacement unit 328. Moving the piston 332 from the first position to the second position may increase the volume of the displacement unit 328. Increasing the volume of the displacement unit 328 may cause an initial reduction in the pressure of the formation fluid. As the pressure drops below the bubble point pressure within the displacement unit 328, formation of bubbles in the displacement unit 328 may be detected during the changes in volume. The gas bubbles in the displacement unit 328 will expand. If the rate of bubble expansion exceeds the rate at which fluid is extracted from the flowline by the displacement unit 328, the first check valve 330a may temporarily close due to the internal spring force, resulting in a temporary pressure increase in flowline 220. The closing of the first check valve 330a is a response to the formation of bubbles in the displacement unit 328, and causes a temporary measured increase in the pressure in the flowline at the intake side of the check valve 330a (we do not have a pressure sensor to measure the pressure of the formation fluid in the displacement unit itself ) . The temporary increase in the pressure may be caused by formation of gas bubbles in the displacement unit 328 that expand and temporarily close the first check valve 330a. The formation of bubbles may cause the temporary increase in the pressure measured in the flowline 220.

As shown in FIG. 3C, the piston 332 may have moved to a third position further expanding the chamber of the displacement unit 328. Bubbles may remain present within the displacement unit 328 and as the piston 332 continues to increase the volume of the displacement unit 328, the pressure therein begins to drop again after the temporary increase in pressure in the flowline 220 (where the pressure sensor may also be located as discussed above) discussed above and illustrated in FIG. 3B. This subsequent drop in pressure may cause the check valve 330a to open again and the pressure continue to drop. Due to the gas forming in the displacement unit 328, the rate of pressure drop may decrease even though the piston 332 has not changed position. The pump 326 may continue to operate,. The sequence illustrated in FIGS. 3A through 3C demonstrates the progression of the piston 332 moving through positions within the displacement unit 328 and the subsequent, corresponding opening and closing of the check valves 330a, 330b in response to the pressure in the displacement unit 328.

The displacement unit 328 may be in fluid communication with the flowline via the first check valve 330a. As described previously, the first check valve 330a may have a cracking pressure such that a pressure in the displacement unit 328 is lower than the pressure in the flowline during the increasing the volume. Multiple sample capture modules may be connected to the section of flowline to decompress. When multiple sample capture modules are connected in combination with light fluids, higher flowrates may be used during the decompression experiment.

The temperature change observed during the decompression experiment may be maintained below approximately 0.5 degrees Celsius to ensure isothermal conditions. In at least one embodiment, the temperature change may be maintained below approximately 0.3 degrees Celsius. In at least one embodiment, the temperature change may be maintained below approximately 1.0 degree Celsius. Factors affecting the temperature change range may include the decompression rate, the thermal conductivity of the formation fluid, the volume of fluid being decompressed, and the thermal mass of the formation testing tool 312 components. Maintaining the temperature change within acceptable ranges may ensure that the decompression experiment proceeds under isothermal conditions, which may improve the accuracy of bubble point pressure determinations.

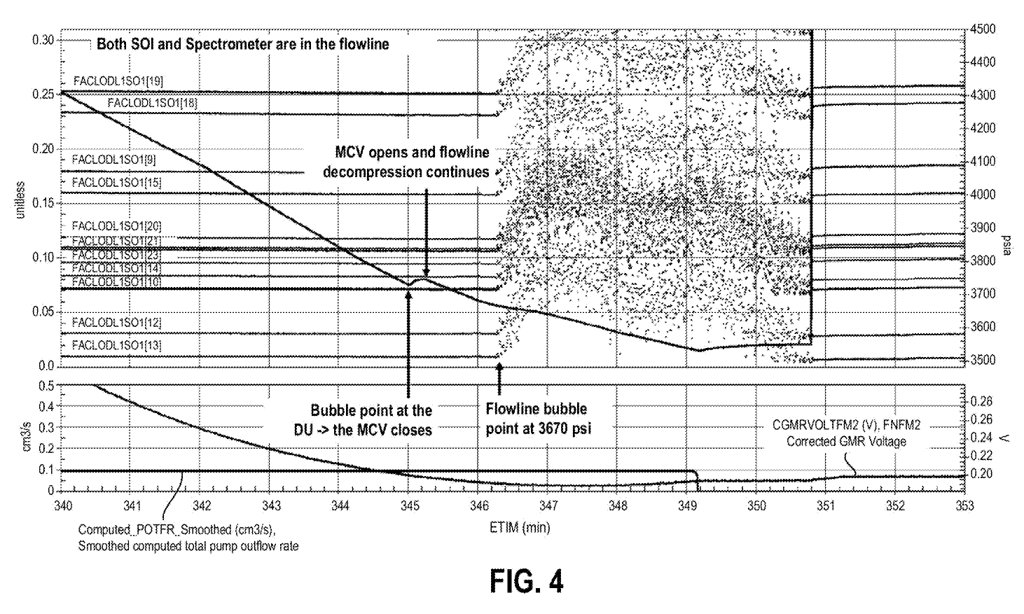

FIG. 4 shows a multi-panel graph showing various measurements plotted against elapsed time during a flowline decompression experiment, such as the flowline decompression experiment illustrated in FIGS. 3A through 3C and described above. The graph displays pressure data, optical density measurements, flow rate data, and displacement unit position data over a time period during which the bubble point pressure may be determined, for example during the time period of the three stages of the decompression experiment illustrated in FIGS. 3A through 3C and described above.

As shown in FIG. 4, a pressure curve shows pressure values in the flowline over elapsed time. The pressure curve illustrates an initial reduction in the pressure of the formation fluid as the displacement pump increases a volume of the displacement unit, which may correlate to the first stage of the experiment shown in FIG. 3A and described above. As described, increasing the volume of the displacement unit in fluid communication with the flowline via a check valve may cause the initial reduction in the pressure of the formation fluid in the flowline. The initial reduction in the pressure may open the check valve, allowing fluid to flow from the flowline into the displacement unit.

While the volume increases, a temporary increase in the pressure may be detected after the initial reduction of the pressure due to the formation of bubbles, as shown in FIG. 3B and discussed above. The temporary increase in the pressure may be observed in the pressure curve shown in FIG. 4 at a point where the pressure stops decreasing and begins to increase or flatten. The temporary increase in the pressure may temporarily close the check valve, as shown in FIG. 3B. Detecting the temporary increase in the pressure may include measuring a pressure in the flowline via a pressure gauge. The pressure sensor may measure the temporary increase in the pressure while the displacement pump continues to increase the volume. The point where the check valve closes and re-opens may be observed in the pressure data shown in FIG. 4. In FIG. 4, the term "MCV" denotes a check valve (e.g., a mud check valve) and "DU" denotes decompression unit. The values, including pressure, volumetric rates, time, and other values in FIG. 4 are given as non-limiting examples for purposes of explanation and illustration. Other embodiments may use or result in different values.

During the increase of the volume, a subsequent and continued reduction in the pressure may be detected, corresponding to the third stage of the experiment shown in FIG. 3C and described above, after the temporary increase in the pressure. The continued reduction in the pressure--often at a reduced decompression rate, because fluid intake into the displacement unit 328 is reduced by the bubbles formed in the displacement unit 328--may be observed in the pressure curve shown in FIG. 4 following the temporary pressure increase. The bubble point pressure may be determined based on the detecting the temporary increase in the pressure. Determining the bubble point pressure may include detecting a time when the check valve temporarily closes and measuring a pressure in the flowline via a pressure gauge at the time.

An optical sensor may be configured to monitor an optical density in the flowline. Monitoring an optical density in the flowline using an optical sensor may be performed during the flowline decompression experiment. A dual-flowline optical spectrometer may interrogate the flowline at a sampling rate of approximately 128 milliseconds during decompression. In at least one embodiment, the sampling rate may range from approximately 50 milliseconds to approximately 250 milliseconds. In at least one embodiment, the sampling rate may range from approximately 100 milliseconds to approximately 200 milliseconds. The sampling rate may be selected based on the expected rate of phase change events and the desired temporal resolution for detecting optical density scattering.

As shown in FIG. 4, optical density measurements from the spectrometer at different wavelengths may be displayed as scattered data points. The optical density data may show relatively stable values during the initial portion of the decompression experiment. Optical density scattering in the flowline may be detected corresponding in time to the continued reduction in the pressure after the temporary increase in the pressure. The optical density scattering may confirm a phase change in the formation fluid. The bubble point pressure may be confirmed based on a pressure value at which the optical density scattering is detected. The controller may be configured to detect optical density scattering in the flowline corresponding in time to the continued reduction in the pressure after the temporary increase in the pressure. As shown in FIG. 4, the increase in pressure, and corresponding closing of the check valve, may occur before the optical scattering occurs, thus allowing precise and accurate detection of the bubble point of the fluid.

A pressure sensor and an optical density sensor may be positioned close enough to each other in the flowline to be considered co-located. The co-location of the pressure sensor and the optical density sensor refers to respective positions close enough to one another where the pressure difference in the flowline at these two positions is negligible, or not separated by a device that will change the pressure such as a flowline restriction or mud check valve. In this way, the co-location of the pressure sensor and the optical density sensor may enable correlation of pressure measurements with optical density measurements during the flowline decompression experiment.

As shown in FIG. 4, a computed giant magnetoresistance (GMR) voltage curve is displayed. A GMR sensor may be used to measure displacement unit volume via piston movement. The GMR sensor may verify that pressure increases are not caused by changes in piston movement. Monitoring a pressure in the flowline during the increasing the volume may be performed in combination with monitoring the displacement unit movement via the GMR sensor. The combination of measuring the displacement unit movement with the GMR sensor and detecting the flowline pressure increasing may demonstrate that the pressure increase is not caused by a change in piston movement.

Detecting whether a temporary increase in the pressure occurs after an initial reduction in the pressure may enable distinguishing between bubble point fluids and dew point fluids. Determining that the formation fluid is a bubble point fluid may be performed in response to detecting the temporary increase in the pressure. Determining that the formation fluid is a dew point fluid may be performed in response to not detecting the temporary increase in the pressure. For dew point fluids, the formation of liquid droplets may not cause a measurable volume change, and the temporary pressure increase may not be observed.

Plotting optical density versus time in addition to plotting data versus pressure may help with quality control of the bubble point pressure determination. When optical density is plotted versus pressure, data doubling may occur. Data doubling in the optical density versus pressure plot may occur when the check valve closes and reopens. The data doubling may result from the pressure decrease, increase, and subsequent decrease during the temporary closure of the check valve. The data doubling may occur at a pressure value above the observed flowline bubble point by an amount approximately equal to the cracking pressure of the check valve. The data doubling phenomenon may mask the true bubble point pressure in the optical density versus pressure plot. Plotting optical density versus time may help to detect the bubble point, particularly for situations where the main flowline optical density scattering occurs close to or at the same time as the flowline pressure increase. The optical density versus time plot may be used for quality control to ensure that the data doubling in the optical density versus pressure plot does not mask the true bubble point pressure.

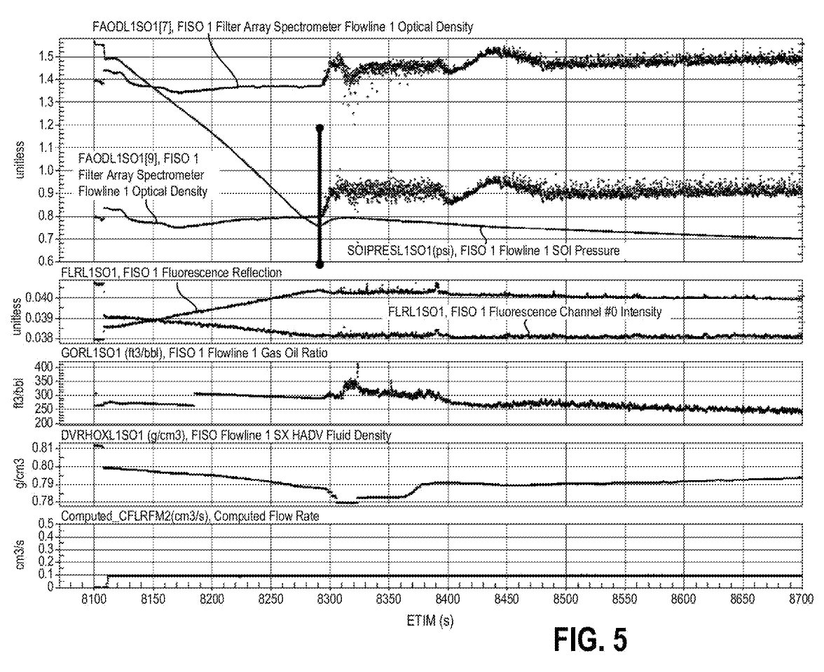

Referring to FIG. 5, a multi-panel graph showing various measurements over time during a flowline decompression experiment is provided. The graph may display optical density measurements, fluorescence measurements, gas oil ratio measurements, fluid density measurements, and flow rate measurements over an elapsed time period. The multiple measurement parameters shown in FIG. 5 may support quality control of bubble point pressure determination during flowline decompression experiments.

As shown in FIG. 5, an uppermost panel may display optical density measurements from a filter array spectrometer. The optical density measurements may be shown as data points representing measurements at different wavelengths. The optical density data may be plotted against elapsed time on the horizontal axis, with pressure data also displayed on a secondary vertical axis. The optical density measurements may show variations corresponding to phase changes in the formation fluid during the decompression experiment.

A second panel from the top may display fluorescence reflection and fluorescence channel intensity measurements. The fluorescence measurements may provide additional information regarding fluid composition and phase behavior during the decompression experiment. The fluorescence data may be used in combination with optical density measurements to confirm phase change events and support quality control of bubble point pressure determinations.

A third panel may display gas oil ratio measurements. The gas oil ratio measurements may show variations during the decompression experiment that correspond to changes in the relative proportions of gas and liquid phases in the formation fluid. The gas oil ratio data may provide supporting information for identifying the pressure at which phase separation occurs.

A fourth panel may display fluid density measurements from a fluid density sensor. The fluid density measurements may show gradual changes over time during the decompression experiment. Changes in fluid density may correspond to phase changes in the formation fluid and may provide additional confirmation of bubble point pressure determinations.

A bottom panel may display computed flow rate measurements. The flow rate data may show the rate at which fluid is being extracted from the flowline during the decompression experiment. The flow rate measurements may be used to verify that the decompression is proceeding at the intended rate and to correlate pressure changes with displacement unit operation.

In at least one embodiment, if the flowline pressure increase is greater than the mud check valve cracking pressure, the pressure increase may be caused by a combination of mud check valve closure and bubble migration. Bubble migration may occur when gas bubbles formed during the decompression experiment move upward through the flowline due to buoyancy effects. The upward migration of bubbles may contribute to pressure increases that exceed the cracking pressure of the mud check valve. A pressure increase of more than approximately 200 psi or approximately 300 psi with optical density scattering being absorbed may indicate bubble upward migration in the flowline. In at least one embodiment, a pressure increase of more than approximately 150 psi to approximately 400 psi may indicate bubble migration effects. Detecting pressure increases that exceed the expected cracking pressure may provide an indication that bubble migration is occurring in addition to the mud check valve closure phenomenon.

In at least one embodiment, a small amount of contamination left in the displacement unit may affect the timing of bubble point detection. The contamination in the displacement unit may cause the bubble point to be reached at a lower pressure in the displacement unit than in the flowline, but because the displacement unit pressure is already lower than the flowline pressure, the detection in the displacement unit and in the flowline can occur at roughly similar times.. In such situations, the flowline optical density scattering may start at the same time as the flowline pressure increase starts. The simultaneous occurrence of optical density scattering and pressure increase may indicate that contamination effects are present. Plotting optical density versus time in addition to plotting optical density versus pressure may help to identify situations where contamination affects the timing of bubble point detection. The time-based plots may enable detection of the true bubble point pressure even when data doubling in the pressure-based plots may mask the bubble point pressure value.

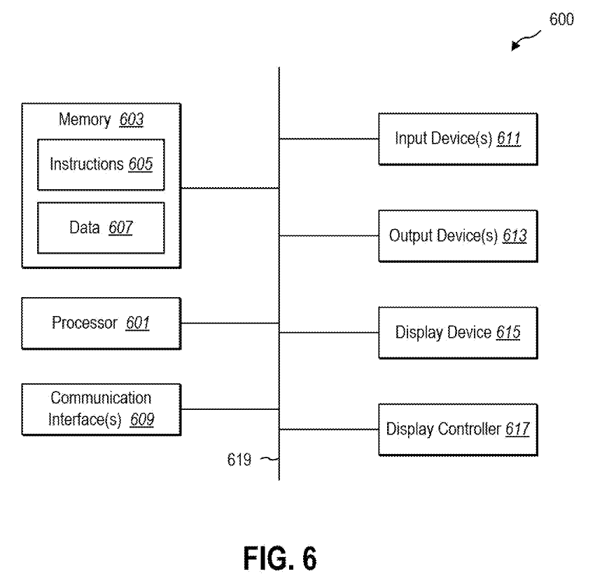

Referring to FIG. 6, a controller computer system 616 may be provided. The controller computer system 616 may be configured to perform bubble point pressure determination and control formation testing operations. The controller computer system 616 may be implemented as part of the controller 116 described previously with reference to FIG. 1, or the controller computer system 616 may be implemented as a separate computing system in communication with the controller 116.

As shown in FIG. 6, the controller computer system 616 may include a processor 601. The processor 601 may be configured to execute instructions to perform various operations related to the flowline decompression experiment and bubble point pressure determination. The processor 601 may process data received from downhole sensors, including pressure sensors and optical sensors positioned in the formation testing tool 312. The processor 601 may perform calculations and analyses to determine bubble point pressure based on detected pressure changes and optical density scattering.

A memory 603 may be included in the controller computer system 616. The memory 603 may be coupled to the processor 601. The memory 603 may store instructions 605 and data 607. The instructions 605 may be executable by the processor 601 to perform the bubble point pressure determination methods described herein. The instructions 605 may include program code for controlling the displacement unit 328 during flowline decompression experiments, detecting temporary pressure increases indicative of bubble point conditions, monitoring optical density measurements, and distinguishing between bubble point fluids and dew point fluids. The data 607 may include pressure measurements received from the pressure gauge 222, optical density measurements received from the fluid analyzer 224, displacement unit position data, and other information collected during formation testing operations.

As shown in FIG. 6, communication interface(s) 609 may be included in the controller computer system 616. The communication interface(s) 609 may enable the controller computer system 616 to communicate with external devices and systems. The communication interface(s) 609 may enable communication with the downhole tool 110, the formation testing tool 312, the pressure gauge 222, the fluid analyzer 224, and the pump 326. The communication interface(s) 609 may support wired or wireless communication protocols for transmitting commands to downhole components and receiving measurement data therefrom.

Input device(s) 611 may be included in the controller computer system 616. The input device(s) 611 may allow users to provide input to the controller computer system 616. The input device(s) 611 may receive commands for initiating flowline decompression experiments, parameters for controlling the pump 326, target decompression rates, and other operational settings. Output device(s) 613 may be included in the controller computer system 616. The output device(s) 613 may provide output from the controller computer system 616, which may include alerts, status information, bubble point pressure values, and processed results from the flowline decompression experiment.

A display device 615 may be included in the controller computer system 616. A display controller 617 may be coupled to the display device 615. The display controller 617 may manage the rendering of visual information on the display device 615. The display device 615 may display graphical representations of pressure versus time data, optical density versus pressure plots, optical density versus time plots, and other visualizations used for quality control of bubble point pressure determinations. The optical density versus time plots displayed on the display device 615 may help to detect the bubble point pressure, particularly for situations where data doubling in the optical density versus pressure plots may mask the true bubble point pressure value.

As shown in FIG. 6, a bus 619 may interconnect the processor 601, the memory 603, the communication interface(s) 609, the input device(s) 611, the output device(s) 613, the display device 615, and the display controller 617. The bus 619 may enable data transfer between the components of the controller computer system 616.

The processor 601 may execute the instructions 605 stored in the memory 603 to cause the pump 326 to increase a volume of the displacement unit 328 resulting in an initial reduction in a pressure of the formation fluid. The processor 601 may execute the instructions 605 to cause the pressure gauge 222 to measure a temporary increase in the pressure while the pump 326 continues to increase the volume. The processor 601 may execute the instructions 605 to determine the bubble point pressure based on the temporary increase in the pressure. The processor 601 may execute the instructions 605 to detect optical density scattering in the flowline 220 corresponding in time to a continued reduction in the pressure after the temporary increase in the pressure. The processor 601 may execute the instructions 605 to distinguish between bubble point fluids and dew point fluids based on whether the temporary pressure increase is detected during the flowline decompression experiment.

The embodiments of downhole tools have been primarily described with reference to wellbores in oil and gas operations. However, the methods, systems, and tools described herein may be used in applications other than the oil and gas operations. One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers’ specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

1. A method for determining a bubble point pressure of a formation fluid during a flowline decompression experiment, the method comprising:
isolating the formation fluid in a flowline of a formation testing tool;
increasing a volume of a displacement unit in fluid communication with the flowline via a check valve to cause an initial reduction in a pressure of the formation fluid in the flowline;
detecting, during the increasing the volume, a temporary increase in the pressure after the initial reduction of the pressure;
detecting, during the increasing the volume, a continued reduction in the pressure after the temporary increase in the pressure;
determining the bubble point pressure based on the detecting the temporary increase in the pressure.

2. The method of claim 1, further comprising:
monitoring an optical density in the flowline using an optical sensor;
detecting, based on the monitoring, optical density scattering in the flowline corresponding in time to the continued reduction in the pressure; and
confirming the bubble point pressure based on a pressure value at which the optical density scattering is detected.

3. The method of claim 1, wherein the detecting the temporary increase in the pressure comprises measuring a pressure in the flowline via a pressure gauge.

4. The method of claim 1, wherein:
the initial reduction in the pressure opens the check valve;
the temporary increase in the pressure temporarily closes the check valve; and
the determining the bubble point pressure comprises:
detecting a time when the check valve temporarily closes; and
measuring the pressure in the flowline via a pressure gauge at the time.

5. The method of claim 1, wherein increasing the volume of the displacement unit comprises moving a piston disposed in the displacement unit.

6. The method of claim 1, wherein the check valve has a cracking pressure such that a pressure in the displacement unit is lower than the pressure in the flowline during the increasing the volume.

7. The method of claim 6, wherein the bubble point pressure is reached in the displacement unit before the bubble point pressure is reached in the flowline.

8. The method of claim 1, further comprising detecting formation of bubbles in the displacement unit during the increasing the volume, wherein the formation of the bubbles causes the temporary increase in the pressure.

9. The method of claim 1, wherein the formation testing tool is disposed in a wellbore, and wherein the method is performed downhole.

10. A system for determining a bubble point pressure during a flowline decompression experiment, comprising:
a formation testing tool configured to isolate a formation fluid in a flowline;
a displacement unit in fluid communication with the flowline, the displacement unit including a displacement pump configured to reduce a pressure in the flowline;
a pressure sensor configured to measure the pressure in the flowline; and
a controller electrically coupled to the displacement pump and the pressure sensor, the controller configured to:
cause the displacement pump to increase a volume of the displacement unit resulting in an initial reduction in the pressure of the formation fluid in the displacement unit;
cause the pressure sensor to measure a temporary increase in the pressure while the displacement pump continues to increase the volume; and
determine the bubble point pressure based on the temporary increase in the pressure.

11. The system of claim 10, further comprising an optical sensor configured to monitor an optical density in the flowline, wherein the controller is further configured to detect optical density scattering in the flowline corresponding in time to a continued reduction in the pressure after the temporary increase in the pressure.

12. The system of claim 10, further comprising a check valve disposed between the flowline and the displacement unit, wherein:
the check valve has a cracking pressure; and
a pressure in the displacement unit is lower than the pressure in the flowline during operation of the displacement pump.

13. The system of claim 12, wherein the check valve is configured to temporarily close in response to the temporary increase in the pressure caused by formation of bubbles in the displacement unit.

14. The system of claim 10, wherein the displacement pump comprises a piston configured to move within the displacement unit to increase the volume of the displacement unit.

15. The system of claim 10, wherein the formation testing tool is configured for deployment in a wellbore, and wherein the controller is configured to determine the bubble point pressure downhole.

16. A method for distinguishing between a bubble point and a dew point during a flowline decompression experiment, the method comprising:
isolating a formation fluid in a flowline of a formation testing tool;
increasing a volume of a displacement unit in fluid communication with the flowline to reduce a pressure of the formation fluid;
monitoring the pressure in the flowline during the increasing the volume;
detecting whether a temporary increase in the pressure occurs after an initial reduction in the pressure;
determining a bubble point pressure of the formation fluid in response to detecting the temporary increase in the pressure; and
determining a dew point of the formation fluid in response to not detecting the temporary increase in the pressure.

17. The method of claim 16, further comprising:
monitoring an optical density in the flowline using an optical sensor; and
detecting optical density scattering in the flowline, wherein the optical density scattering confirms a phase change in the formation fluid.

18. The method of claim 16, wherein:
the displacement unit is in fluid communication with the flowline via a check valve; and
the temporary increase in the pressure is caused by formation of gas bubbles in the displacement unit that expand and temporarily close the check valve.

19. The method of claim 18, wherein the check valve has a cracking pressure such that the pressure in the displacement unit is lower than the pressure in the flowline during the increasing the volume, and wherein a phase change occurs in the displacement unit before occurring in the flowline.

20. The method of claim 16, wherein the formation testing tool is disposed in a wellbore, and wherein the method is performed downhole.
